(19) United States
(12) Patent Application Publication
(10) Pub. No.: US 2018/0039061 A1
(43) Pub. Date: Feb. 8, 2018

(54) APPARATUS AND METHODS TO GENERATE IMAGES AND DISPLAY DATA USING OPTICAL DEVICE

(71) Applicant: Viuw, Inc., Dixon, CA (US)

(72) Inventors: Jason Hairston, Dixon, CA (US); Kenneth E. Salsman, Pleasanton, CA (US); Kent G. Davidson, Pleasanton, CA (US); Joel Swan, Lubbock, TX (US)

(73) Assignee: Viuw, Inc., Dixon, CA (US)

(21) Appl. No.: 15/226,637

(22) Filed: Aug. 2, 2016

(51) Int. Cl. G02B 23/12; G02B 23/04; H04N 5/225; F41G 3/26; F41G 1/38; F41G 3/06; F41G 3/08; F41G 3/14; G02B 27/14; H04N 7/18

(52) U.S. Cl. CPC G02B 23/12; G02B 27/14; G02B 23/04; H04N 5/2252; H04N 7/183; F41G 1/38; F41G 3/06; F41G 3/08; F41G 3/14; F41G 3/2611

(57) ABSTRACT

Apparatus and methods are disclosed to share images observed through an optical device and display data through the optical device. An input/output device may be positioned in an optical path of the optical device. The input/output device may include a beam splitter to redirect a portion of a beam of light traveling along the optical path of the optical device to an imaging device. The beam splitter may also combine the beam of light with another beam of light generated by a display device.

### TECHNICAL FIELD

The present disclosure relates generally to systems and methods to capture, display, and share images captured by an optical device. More particularly, the present disclosure relates to capturing and sharing images captured by a scope for a rifle.

### BACKGROUND

Optical devices such as telescopes, binoculars, and hunting scopes have long been used to magnify images seen at a distance. The magnification of objects at a distance allows the user of the optical device to make more informed decisions about what they are looking at. For example, Galileo used a telescope to help establish that the sun was indeed the center of the solar system.

Hunting scopes attached to rifles and other weapons also provide advantages to hunters and marksmen. A hunting scope may be coupled to rifle to improve the accuracy of the marksman and may effectively increase the usable range of the rifle. Because distant objects appear to be closer when looking through a hunting scope, a marksman may find it easier to precisely target an object with the hunting scope.

One typical drawback of optical devices is that only one user may view an object through the optical device at a time. There is a need to be able to share images captured by an optical device with others, without distorting the image observed by the user of the optical device. Another drawback of optical devices is that the user of the optical device cannot analyze any additional information while looking through optical device. The optical device tends to fill the user's entire field of view. There is a need to be able to display supplemental information to a user of the optical device through the optical device.

### SUMMARY

An aspect of the present disclosure relates to an apparatus for sharing images and outputting data via an optical device. The apparatus may include an optical device having a housing with objective optics positioned at a first end of the housing and ocular optics positioned at a second end of the housing, the optical device may define a primary optical path between the objective optics and an exit pupil, a beam splitter may be positioned in the primary optical path and configured to divide a primary beam traveling along the primary optical path into a first beam traveling along the primary optical path and a second beam traveling along an auxiliary optical path different than the primary optical path, and one or more auxiliary lenses may be positioned in the auxiliary optical path to focus the second beam on a lens of a camera.

The apparatus may also include a camera housing positioned adjacent to an auxiliary exit pupil defined by the auxiliary optical path, the camera housing may be sized to receive the camera and configured to secure the camera in a fixed position relative to the auxiliary exit pupil. The beam splitter may be positioned in the primary optical path between the ocular optics and the exit pupil. The apparatus may also include an auxiliary housing coupled to the housing of the optical device at the second end, the one or more auxiliary lenses may be positioned within a beam splitter housing. The apparatus may also include one or more primary lenses positioned in the primary optical path between the beam splitter and the exit pupil to alter a position of the exit pupil relative to the ocular optics. The one or more primary lenses may be configured to adjust an eye relief of the optical device based at least in part on the position of the beam splitter in the primary optical path. The beam splitter may be positioned in the primary optical path between the objective optics and the ocular optics. The housing may further include an opening being positioned to allow the second beam to exit the housing at a location different from the ocular optics.

Another aspect of the present disclosure relates to an apparatus for sharing images and outputting data via an optical device. The apparatus may include an optical device having a housing with objective optics positioned at a first end of the housing and ocular optics positioned at a second end of the housing, the optical device may define a primary optical path, a beam splitter positioned in the primary optical path to divide a first objective beam traveling from the objective optics along the primary optical path into a second objective beam and third objective beam, the third objective beam traveling along an auxiliary optical path different than the primary optical path, and a display positioned to cooperate with the beam splitter to define a display optical path, the display to generate a display beam that travels along the display optical path to the beam splitter, the display optical path being different than the primary optical path, the second objective beam and the display beam cooperate to present an image at an exit pupil of the optical device.

The image presented at the exit pupil may include an objective represented in the first objective beam and support information represented in the display beam. The support information may include environmental information. The support information may include a targeting correction indicator. The beam splitter may combine the first objective beam and at least a portion of the display beam into an ocular beam that travels along the primary optical path to the exit pupil. The third objective beam may travel along the auxiliary optical path to an imaging device, the third objective beam presenting an auxiliary image of an objective at an auxiliary exit pupil of the optical device. The beam splitter may form the second objective beam by allowing a first portion of the objective beam to pass through the beam splitter and travel along the primary optical path. The beam splitter may form the third objective beam by reflecting a second portion of the objective beam along the auxiliary optical path. The beam splitter may divide the display beam into a second display beam traveling along the primary optical path and a third display beam traveling along the auxiliary optical path. The third objective beam and the third display beam may cooperate to define an auxiliary image at an auxiliary exit pupil that includes an objective represented in the first objective beam and support information represented in the display beam. The apparatus may also include a wireless communication device receive support information from one or more other computing devices via a communication network.

Another aspect of the present disclosure relates to a method for sharing images and outputting data via an optical device. The method may include receiving, via a beam splitter of an I/O device, a beam of light traveling from objective optics of an optical device, the optical device defining an optical path, the beam splitter being positioned in the optical path and configured to intercept the beam of light, reflecting from a first surface of the beam splitter at least a portion of the beam of light to an imaging device of the I/O device, transmitting an image generated by the I/O device from the portion of the beam of light to a computing device, obtaining, by the I/O device, support data indicative of one or more conditions present around the optical device, and reflecting from a second surface of the beam splitter at least a portion of a beam of light generated by a display device, the beam of light generated by the display device including one or more indicators based at least in part on the support data, wherein the indicators are output to a user at ocular optics of the optical device.

The method may also include receiving a visual indicator from the computing device, the visual indicator being input by drawing on the image output by the computing device. The method may also include outputting the visual indicator at the ocular optics to the user of the optical device. The method may also include identifying one or more characteristics of an animal present in the image. The method may also include determining animal tracking data based at least in part on the one or more characteristics of the animal. The method may also include outputting animal tracking data at the ocular optics to the user of the optical device. The support data may include receiving, via a computer network, the support data from one or more other devices positioned in a proximity to the optical device. The support data may also include at least one of a wind speed, a wind direction, a range to an objective, an altitude, or a location of the optical device. The one or more other devices may include at least one of a range finder, an altimeter, a global positioning system device, an anemometer, a wind vane, or a thermal imager.

The method may also include determining a targeting correction based at least in part on the image and the support data. The method may also include outputting a targeting correction indicator at the ocular optics to the user of the optical device based at least in part on the targeting correction. The method may also include determining a direction that the optical device is pointed based at least in part the image received from the optical device and location data indicative of a location of the optical device. The method may also include warning the user of the optical device of any possible hazards if a weapon is discharged in the direction that the optical device is pointed. The method may also include determining a targeting skill parameter for the user based at least in part on a position of an objective in the image obtained by the optical device or based at least in part on a location of a projectile as it moves past the objective. The method may also include comparing the targeting skill parameter of the user to one or more other targeting skill parameters of other users of other optical devices. The method may also include indicating which of the users had a best targeting skill parameter.

### BRIEF DESCRIPTION OF THE DRAWINGS

A further understanding of the nature and advantages of the embodiments may be realized by reference to the following drawings. In the appended figures, similar components or features may have the same reference label.

FIG. 1 shows a perspective view of an example of an optical device with a digital input/output device coupled thereto.

FIG. 2 shows a simplified block diagram of the digital input/output device of FIG. 1.

FIG. 3 shows a simplified block diagram of the digital input/output device including image capture components.

FIG. 4 shows a simplified diagram of an example of a networked image sharing system using the digital input/output device and a computing device.

FIG. 5 shows a simplified block diagram of optical paths created by the cooperation of the optical device and the digital input/output device.

FIG. 6 shows a simplified block diagram of the digital input/output device including data display components.

FIG. 7 shows examples of images seen through the optical device of FIG. 1.

FIG. 8 shows a simplified block diagram of optical paths created by the cooperation of the optical device and the digital input/output device.

FIG. 9 shows a simplified block diagram of an optical device and a digital input/output device positioned within the optical device.

FIG. 10 shows a simplified block diagram of an optical device and a digital input/output device positioned between the optical device and the user's eye.

FIG. 11 shows a simplified block diagram of a network for communicating images and information with an optical device.

FIG. 12 shows an example of a hardware environment for using a digital input/output device.

FIG. 13 shows a perspective view of the digital input/output device of FIG. 1.

FIG. 14 shows a simplified block diagram of an example of a housing of the digital input/output device.

FIG. 15 shows a simplified block diagram of another example of a housing of a digital input/output device.

FIG. 16 shows a simplified flow chart for using the optical device and the digital input/output device.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The present disclosure is generally directed toward technologies for capturing images seen through an optical device, such as a scope, without distorting or obscuring the view of the user of the optical. The technologies may also share the images with a computing device in real-time such that another person using the computing device may view what the user sees in real-time. The technologies may also obtain and display information via the optical device to the user. The technologies described herein describe apparatus and methods that may be used to integrate an optical device with the other devices.

In the proposed design, a digital input/output (“I/O”) system may include a camera, a beam splitter, optics (e.g., lenses, mirrors, etc.), and a housing that encloses circuitry used to capture and communicate the image seen through the scope. The digital I/O system may also include electronic circuitry for processing the image and for communicating the image to other devices, such as a mobile computing device. A beam splitter may redirect a first portion of a beam traveling through an optical device toward the camera. The beam splitter may also allow a second portion of the beam to pass through the beam splitter and continue on to the user's eye. In this way, both the user and the camera may be configured to observe the image being presented by the optical device.

In the hunting context, a hunting scope may be equipped with the image capture/display device. A marksman may desire to share the image being seen through the hunting scope with another person. For example, during marksman training, a student or teacher may desire to view what the other sees through the hunting scope.

In this way, the teacher may be able to offer more specific advice to the help the student improve or the student may be able to observe first-hand the proper way to use the hunting scope. The marksman may desire to evaluate other information without interrupting the use of the hunting scope. For example, the marksman may desire to know the wind speed or the range to the objective without taking his or her eyes away from the hunting scope. In some instances, the situation is not well suited for audible communication.

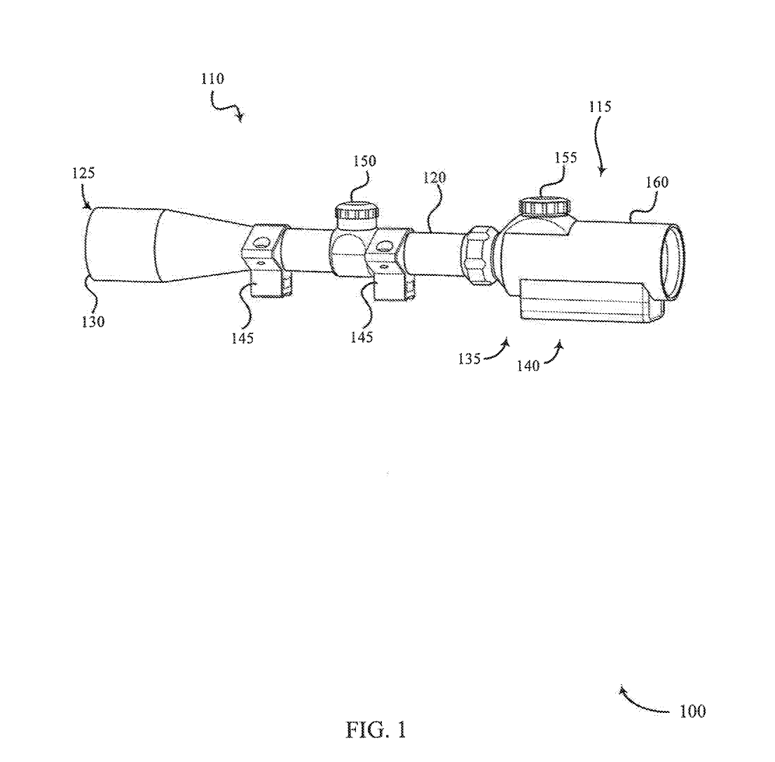

FIG. 1 shows an example 100 of an optical device 110 with a digital input/output device 115 (hereinafter “I/O device 115”). The optical device 110 may be any type of optical device to produce or control light. For example, the optical device 110 may be embodied as a scope, a telescope, a microscope, a hunting scope, a range finder, a spy glass, binoculars, or any other type of optical device.

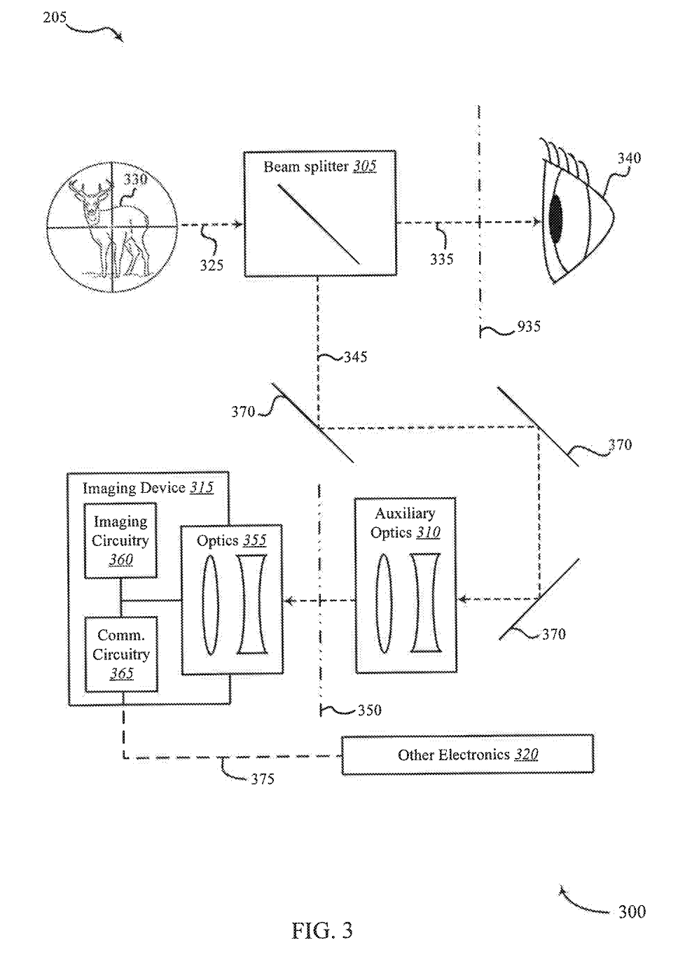

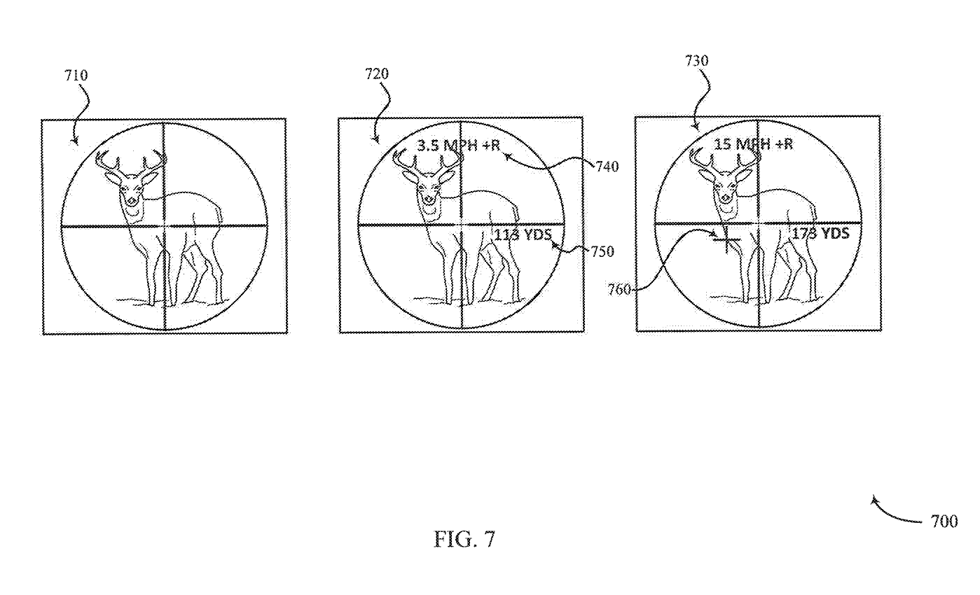

The optical device 110 may include a housing 120 with objective optics 125 positioned at a first end 130 of the optical device 110 and ocular optics 135 (not shown in FIG. 1) positioned at a second end 140 of the optical device 110, The objective optics 125 are designed to be pointed at an objective 330 and to gather light into the optical device 110. The objective 330 (see FIG. 3 or 7) may be vary depending on the type of optical device 110 being used the application of that use. For example, the objective of an astronomy telescope may be celestial objects like the moon, stars, planets, or comet. In another example, the objective of binoculars or a hunting scope may be an animal being hunted like a deer or elk. The ocular optics 135 are designed to direct the light gathered by the objective optics 125 and present that light to a user of the optical device 110. An eye 340 of a user may be positioned near the ocular optics 135 during normal use of the optical device 110 (see FIG. 3, 9, or 10).

As used in this disclosure, optics may be any optical device designed to alter affect a beam of light. For example, optics may include lenses, filters, mirrors, other light redirectors, prisms, refractors, splitters, or other types of light-altering device. In some examples, the optics may be passive elements, such as lenses and mirrors. In other examples, the optics may be active elements, such as powered devices used to alter the light. Optics may also include any number of light-altering devices. For example, optics may include one or more lenses positioned to redirect light in a particular manner. A lens is a transparent optical device used to converge or diverge transmitted light and to form images. Frequently in optical devices, many different types of lenses are used to obtain the desired result. Types of lenses may include both converging lenses and diverging lenses. Converging lenses may include a convex lens, biconvex lens, plano-convex lens, or a positive meniscus lens. Diverging lenses may include a concave lens, a biconcave lens, a plano-concave lens, or a negative meniscus lens.

The illustrative optical device 110 is a scope configured to be mounted on a rifle or other type of firearm 410. The objective optics 125 and the ocular optics 135 may be positioned in the housing 120. The optical device 110 may also include mounts 145 positioned on the housing 120. The mounts 145 may be configured to couple the optical device 110 in a fixed position relative to a firearm 410. The optical device 110 may also include an elevation adjustor 150 and a power adjustor 155. In some examples, the optical device 110 may also include a wind adjustor. In some examples, other optics are positioned in the housing 120 between the first end 130 and the second end 140. These other optics, in some examples, may be included as part of the objective optics 125 or the ocular optics 135.

The illustrative I/O device 115 is embodied as an attachment to the optical device 110 and is configured to be attached to the second end 140 (e.g., near the ocular optics 135) of the optical device 110. In other examples, the I/O device 115 may be integrated into the optical device 110 itself, as is discussed in more detail below. The I/O device 115 may include an I/O housing 160. Optics and electronic circuitry including an imaging device and communication circuitry may be positioned within the I/O housing 160.

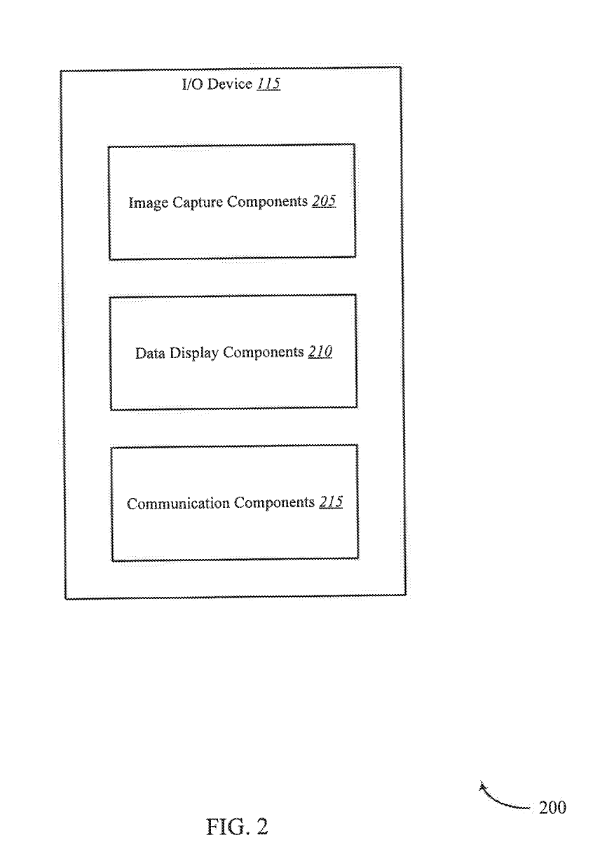

FIG. 2 shows a simplified block diagram of the I/O device 115. The I/O device 115 may include image capture components 205, data display components 210, and communication components 215. The components 205, 210, 215 described herein may be embodied as hardware, software, firmware, mechanical devices, or other components to perform the functions described herein.

The image capture components 205 may be configured to capture an image or video observed by a user through the optical device 110. Once captured, the image or video may be stored in a storage media (e.g., memory, flash memory, film, etc.) or image or vide may be shared with another computing device. In some examples, the image or video may be transmitted to the other computing device in real-time. The I/O device 115 may use the communication components 215 to transmit the image or video to another computing device, to a data storage device, or some other type of device via a network.

The data display components 210 are configured to obtain support data (e.g., wind direction, wind speed, range to objective 330, etc.) relevant to the user of the optical device 110 and present that support data to the user through the optical device 110. The support data may be obtained from circuitry and devices integrated into the I/O device 115, from other computing devices or from other devices (e.g., servers) connected via a network. In some examples, the data display components 210 may generate indicators that may be superimposed on the image being observed by the user through the optical scope. The I/O device 115 may use the communication components 215 to obtain or otherwise communicate the support data with other computing devices, servers, or other devices via network.

FIG. 3 shows a simplified block diagram 300 of an example of image capture components 205. The image capture components 205 may be positioned in the I/O housing 160; however, the I/O housing 160 is not shown in block diagram 300. The image capture components 205 may include a beam splitter 305, auxiliary optics 310, an imaging device 315, and other electronics 320.

The beam splitter 305 may be positioned in an optical path of the optical device 110. The beam splitter 305 may be an optical components used to split a beam 325 of light at a designated ratio into two or more separate beams. In the illustrative example, the beam splitter 305 splits the beam 325 into two beams, into an ocular beam 335 that travels to a user's eye 340 and an auxiliary beam 345 which travels to the imaging device 315. In addition, the beam splitter 305 may also combine two or more beams into a single beam of light. The beam splitter 305 may be a cube beam splitter or a plate beam splitter.

The beam splitter 305 may be configured partially transmit the beam 325 and partially reflect the beam 325. The beam splitter 305 may allow a first portion of the beam 325 to transmit through the beam splitter 305 and continue along the same direction as the beam 325. The beam splitter 305 may also reflect a second portion of the beam 325 in a direction different than the direction of the beam 325. In some examples, the beam splitter 305 may transmit 50% of the beam 325 and may reflect 50% of the beam 325. In other examples, the beam splitter 305 may split the beam 325 into unequal portions. The beam splitter 305 may be embodied as a plate beam splitter 305 made of glass having a dielectric coating on a surface facing the beam

The auxiliary optics 310 may be positioned in a cavity formed by the I/O housing 160. The auxiliary optics 310 may be positioned in the path of the auxiliary beam 345 between the beam splitter 305 and an auxiliary exit pupil 350. The auxiliary optics 310 may include one or more lenses to collect, diffract, or focus the auxiliary beam 345. The auxiliary optics 310 may be configured to adjust a focus of the auxiliary beam 345 so that that the imaging device 315 captures an image or video observed by the user through the optical device 110. It is important to note, that the image or video need not always be observed by a person to be captured by the imaging device 315. Merely that the optical device 110 gathers light and the imaging device 315 captures of portion of that light and generates a video or an image. In some examples, the auxiliary optics 310 are configured to adjust a position, an orientation, or a diameter of the auxiliary exit pupil 350. While optics 355 of the imaging device 315 are shown to be positioned away from the auxiliary exit pupil 350, in some examples, the optics 355 of the imaging device 315 are positioned at the location of the auxiliary exit pupil 350.

The imaging device 315 may be embodied as any type of suitable imaging device. For example, the imaging device 315 may be a camera, a CCD, or other type of imaging device. The imaging device 315 may be positioned in the cavity of the I/O housing 160. The imaging device 315 may be coupled to the I/O housing 160 in a fixed position relative to the I/O housing 160. In some examples, the imaging device 315 may be built into the I/O housing 160 such that it is permanently integrated into the I/O housing 160.

The imaging device 315 may include a optics 355, imaging circuitry 360, and communication circuitry 365. The optics 355 may be positioned to receive the auxiliary beam 345 into the imaging device 315. In some examples, the optics 355 may be lenses configured to gather light into the imaging device 315 and focus it on a sensor positioned within the optical device. In other examples, the optics 355 may not exist and the sensor may be positioned at the auxiliary exit pupil 350. The imaging circuitry 360 may include any circuity and/or components needed to capture an image. For example, the imaging circuitry 360 may include a processor, memory and a sensor (e.g., a CCD sensor) to generate a digital image of the image. The communication circuitry 365 may include any circuitry or components needed to communicate the generated image to a network, such as network 420 discussed later.

The other electronics 320 may include any other circuitry, components or devices used by the I/O device 115 to perform the functions described herein. For example, the other electronics 320 may include a processor, memory, a power source (e.g., a battery), a user interface, and communication circuitry to connect the I/O device 115 to a network, such as network 420. In some examples, the I/O device 115 includes one or more user interfaces, such as a touchscreen, buttons, toggles, and/or indicators. A user may interact with one of the user interfaces to alter one or more settings of the I/0 device 115. In some examples, the communication circuitry includes circuitry to communicate via both wired networks and wireless networks. For example, I/O device 115 may include a wired data port, such as a USB or mini USB port. In such examples, the communication circuitry may include components to support such a wired connection. In some examples, the other electronics 320 may be coupled to the communication circuitry 365 via a link 375. In such an example, the imaging device may not connect directly to the network 420, but may connect to the other electronics 320, which in turn connect to the network 420. In some examples, the other electronics 320 may include a solid state memory.

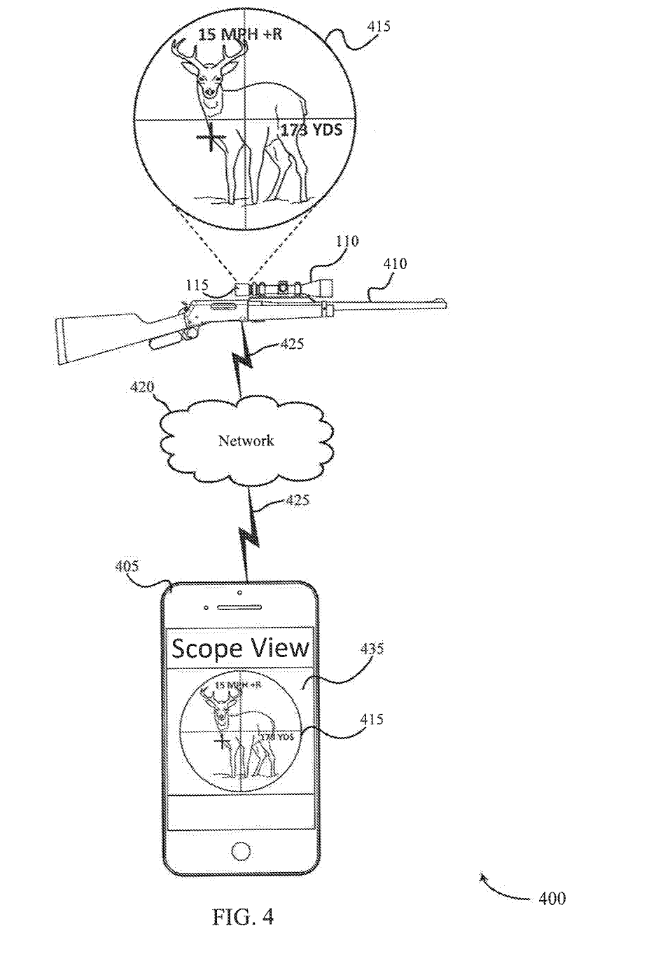

In use, the optical device 110 collects light from an objective 330 and forms the beam 325. The objective 330 may be the object being viewed by the optical device 110. For example, the objective 330 seen through a hunting scope may be a deer or another animal. The beam splitter 305 splits the beam 325 into the ocular beam 335 and the auxiliary beam 345. The ocular beam 335 is transmitted through the beam splitter 305 and travels to a user's eye 340, during normal operation of the optical device. The auxiliary beam 345 is reflected by the beam splitter 305 and travels to the imaging device 315. In the illustrative example, a number of mirrors 370 may be positioned to redirect the auxiliary beam 445. The auxiliary beam 445 may be redirected based on the space constraints of the I/O housing 160. In other examples, either zero, one, two, or more mirrors 370 are used to redirect the auxiliary beam 445. While three mirrors 370 are shown in the illustrative embodiment of FIG. 3, some embodiments include only one mirror 370. The auxiliary optics 310 focus and/or adjust the position, orientation, or the size of the auxiliary exit pupil 350. The imaging device 315 may be positioned at the auxiliary exit pupil 350 and may capture an image or video of the objective 330 based at least in part on auxiliary beam 445. As shown in FIG. 4, the image or video may be communicated to other computing devices via a network.

FIG. 4 shows an example of a I/O network 400 using the optical device 110, the I/O device 115, and a computing device 405. In the illustrative example, the optical device 110 is coupled in a fixed position relative to a firearm 410. The illustrative example of FIG. 4, shows sharing an image 415 (or video) captured by the image capture components 205 with another computing device 405.

The I/O device 115 may be configured to communicate the image 415 in real-time to the computing device 405 using a network 420 via communication links 425. The I/O device 115 may use the communication components 215 to perform the communications. As shown in FIG. 4, the image 415 being observed by the user of the optical device 110 (during normal operations) may be displayed simultaneously on a display 435 of the computing device 405. This way, multiple people may observe the image 415 simultaneously, when previously only one person could observe the image 415 gathered by the optical device 110 at a time. Using this view sharing, people may share information, tips, tricks, other judgments, or may evaluate performance. In some examples, the image 415 may also be stored in storage media to be viewed at a later date. In some examples, the image 415 may be stored as stream of images or a video.

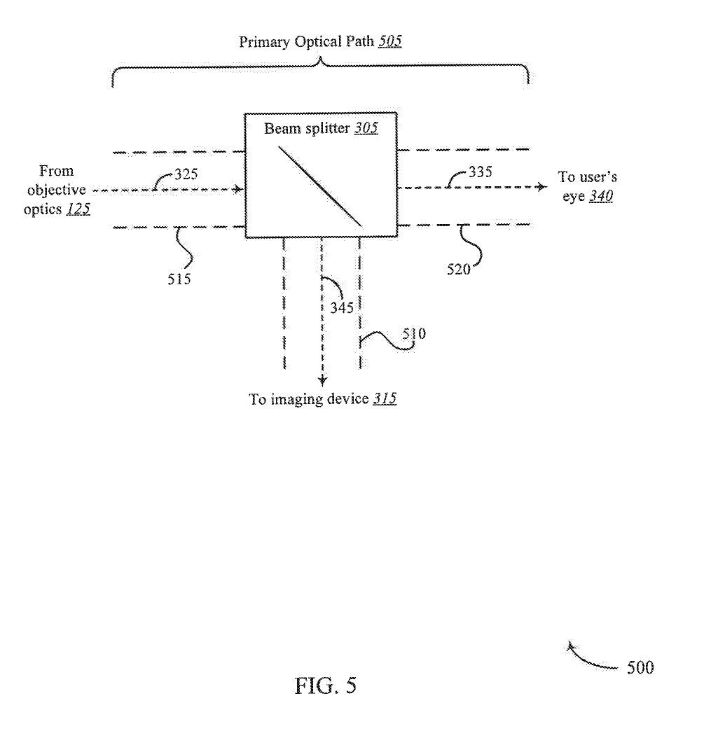

FIG. 5 shows a simplified block diagram 500 of optical paths created by the cooperation of the optical device 110 and the I/O device 115. The optical device 110 may define a primary optical path 505 between the objective optics 125 and the exit pupil 935 defined by the optical device 110. The primary optical path 505 may be defined as the path that light takes as it traverses the optical device 110. During normal operation, light enters the optical device 110 through the objective optics 125, may pass through a series of other optics, exits the optical device 110 through the ocular optics 135 and is focused at the exit pupil 935. While the illustrative example, shows that the primary optical path 505 is straight, in other examples, the primary optical path 505 may travel in many different directions.

The beam 325 travels along the primary optical path 505 to the user's eye 340. While the beam 325 is shown as a single beam traveling in a straight line, the beam 325 may be a collection of beams traveling on the primary optical path 505.

As described above, a beam splitter 305 may be positioned in the primary optical path 505. The beam splitter 305 may be used to split the beam 325 into the ocular beam 335 and the auxiliary beam 345. The ocular beam 335 may travel to the exit pupil 935 and, in normal operation, to the user's eye 340. The auxiliary beam 345 may along an auxiliary optical path 510 to the imaging device 315. In some examples, the primary optical path 505 may be split into an objective optical path 515, positioned before the beam splitter 305, and an ocular optical path 520, positioned after the beam splitter 305.

The auxiliary optical path 510 may be defined as the path that light takes as it travels from the beam splitter 305 to the auxiliary exit pupil 350 and to the imaging device 315. The auxiliary optical path 510 may not be straight.

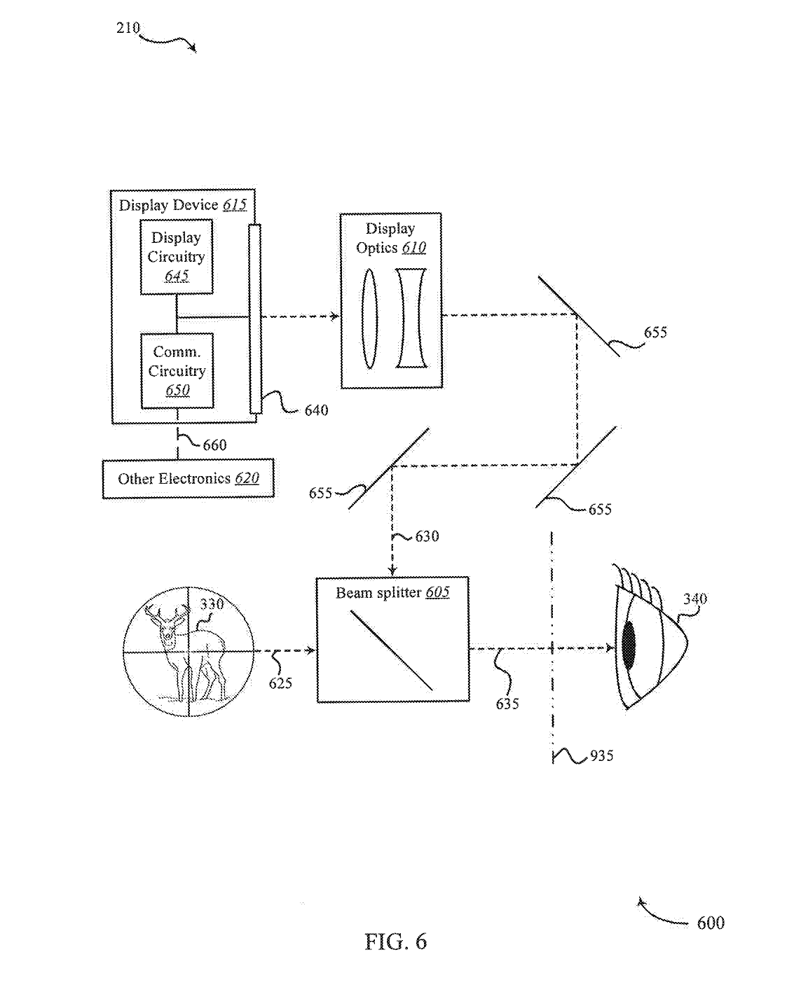

FIG. 6 shows a simplified block diagram 600 of an example of the data display components 210, The data display components 210 may be positioned in the I/O housing 160; however, the I/O housing 160 is not shown in block diagram 600. The data display components 210 may include a beam splitter 605, display optics 610, a display device 615, and other electronics 620.

The beam splitter 605 may be positioned in an optical path (e.g., primary optical path 505) of the optical device 110. The beam splitter 605 may be an optical components used to combine a beam 625 of light into a display beam 630 of light to create an ocular beam 635 of light that travels to a user's eye 340. In addition, the beam splitter 605 may also separate or a beam of light into multiple beams of light. In some examples, the beam splitter 605 may split and combine different beams of light.

The beam splitter 605 may be configured to transmit at least a portion of the beam 625 and to reflect at least a portion of the display beam 630. In some examples, the beam splitter 305 may transmit a percentage of the beam 625 and may reflect a percentage of the display beam 630. These percentages of beams 625, 630 may be combined into the ocular beam 635. In some examples, the beam splitter 605 may combine equal portions of beam 625 and display beam 630. In other examples, the beam splitter 605 may combine unequal portions of beam 625 and display beam 630 (e.g., 70% of one beam and 30% of the other beam). The beam splitter 605 may be embodied as a plate beam splitter made of glass having a dielectric coating on a surface facing the display beam 630.

The display optics 610 may be positioned in a cavity formed by the I/O housing 160. The display optics 610 may be positioned in the path of the display beam 630 between the beam splitter 605 and the display device 615. The display optics 610 may include one or more lenses to collect, diffract, or focus the display beam 630. The display optics 610 may be configured to adjust a focus of the display beam 630 so that that the information and/or images presented by the display device 615 are accurately output from the optical device 110.

The display device 615 may be embodied as any type of suitable display device. For example, the display device 615 may be a cathode ray tube display (CRT), a light-emitting diode display (LED), an electroluminescent display (ELD), a plasma display panel (PDP), a liquid crystal display (LCD), a thin-film transistor display (TFT), an organic light-emitting diode display (OLED), or any other type of display device. The display device 615 may be positioned in the cavity of the I/O housing 160. The display device 615 may be coupled to the I/O housing 160 in a fixed position relative to the I/O) housing 160. In some examples, the display device 615 may he built into the I/O) housing 160 such that it is permanently integrated into the I/O housing 160.

The display device 615 may include a light source 640, display circuitry 645, and communication circuitry 650. The light source 640 may be positioned to transmit the display beam 630 into the display optics 610 and the beam splitter 605. The display circuitry 645 may include any circuity and/or components needed to generate an image based at least in part on support data obtained by the I/O device 115. For example, the display circuitry 645 may generate one or more images indicating a wind speed and a wind direction. The display circuitry 645 may include a processor, memory and a source to generate an image based on the support data. The communication circuitry 650 may include any circuitry or components needed to communicate and/or obtain the support data from a network, such as network 420.

The other electronics 620 may include any other circuitry, components or devices used by the I/O device 115 to perform the functions described herein. For example, the other electronics 620 may include a processor, memory, a power source (e.g., a battery), a user interface, and communication circuitry to connect the I/O device 115 to a network, such as network 420. In some examples, the I/O device 115 includes one or more user interfaces, such as a touchscreen, buttons, toggles, and/ or indicators. A user may interact with one of the user interfaces to alter one or more settings of the I/O device 115. In some examples, the communication circuitry includes circuitry to communicate via both wired networks and wireless networks. For example, I/O device 115 may include a wired data port, such as a USB or mini USB port. In such examples, the communication circuitry may include components to support such a wired connection. In some examples, the other electronics 620 may be coupled to the communication circuitry 650 via a link 660. In such examples, the display device 615 may not connect directly to the network 420, but may connect to the other electronics 620, which in turn connect to the network 420. In some examples, the other electronics 620 may include a solid state memory. The other electronics 620 may be similarly embodied as the other electronics 320.

In use, the optical device 110 collects light from the objective 330 and forms the beam 625. The display device 615 emits light (shown as the display beam 630) indicative of support data to be presented to a user of the optical device 100 during normal operation of the optical device 110. The display beam 630 passes through display optics 610 and may be altered by the display optics 610. The display beam 630 may be redirected based on the space constraints of the I/O housing 160. In other examples, either zero, one, two, or more mirrors 655 are used to redirect the display beam 630. While three mirrors 655 are shown in the illustrative embodiment of FIG. 6, some embodiments include only one mirror 655. The beam splitter 605 may combine the beam 625 and the display beam 630 to create the ocular beam 635. The ocular beam may present an image to the user's eye 340 that includes the objective 330 in beam 625 and the support data in display beam 630. More specifically, the beam splitter 605 may transmit at least a portion of the beam 625 through the beam splitter 605 towards a user's eye 340 and reflect at least a portion of the display beam 630 towards a user's eye 340.

FIG. 7 shows examples of views 700 that may be observed through the optical device 110 using data display components 210 of the I/O device 115. The images may include a traditional view 710, a digital info view 720, and a shot correction view 730. The traditional view 710 represents an image a user would see through the optical device 110 that does not include an I/O device 115. The digital info view 720 includes support data superimposed on the image observed through the optical device 110. For example, a wind speed indicator 740 and a range-to-objective indicator 750 may be superimposed on the traditional view 710. The shot correction view 730 also includes a shot correction indicator 760 superimposed on the traditional view 710. In some examples, the I/O device 115, or another computing device in communication with the I/O device 115 via a network, may obtain support data and determine a shot correction parameter. For example, using a distance-to-target and a wind vector, the shot correction parameter may indicate that the firearm 410 may be pointed in a different direction than what is indicated by the reticles in order to hit the objective. In some examples, the shot correction indicator 760 may by dynamically superimposed on the traditional view 710 such that as the optical device 110 is moved, the position of the shot correction indicator 760 is adjusted. In this manner, a user of the optical device 110 may align the reticles of the optical device 110 with the shot correction indicator 760.

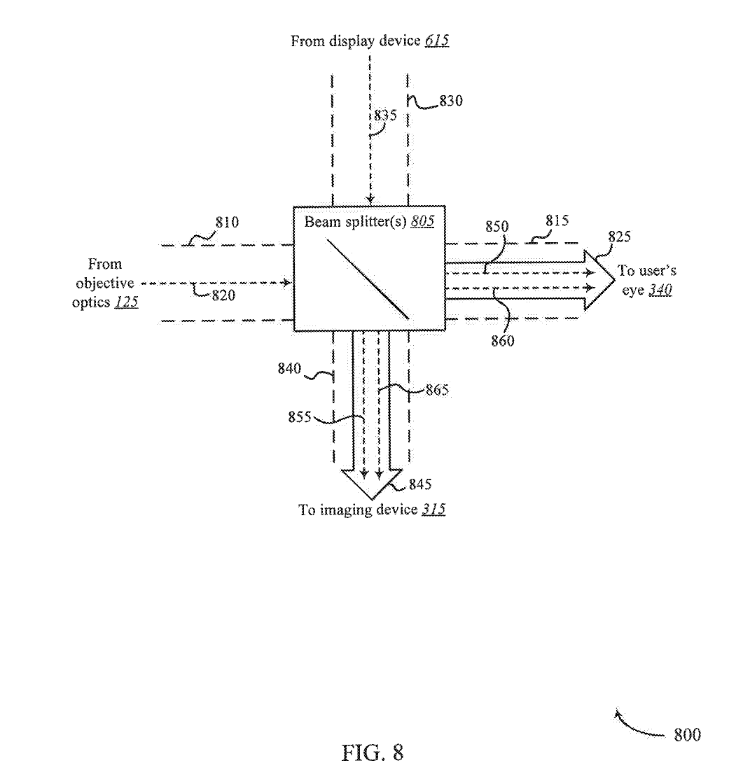

FIG. 8 shows a simplified block diagram 800 of optical paths created by the cooperation of the optical device 110 and the I/O device 115. The block diagram 800 shows the optical paths and beams of light created by an I/O device 115 that includes both the image capture components 205 and the data display components 210. In other examples, an I/O device that only includes the data display components 210 may define optical paths similar to those depicted in FIG. 5.

The beam splitter(s) 805 may be positioned in a primary optical path of the optical device 110. The primary optical path may include an objective optical path 810 positioned between the objective optics 125 and the beam splitter(s) 805 and an ocular optical path 815 positioned between the beam splitter(s) 805 and the exit pupil 935. An objective beam 820 may travel along the objective optical path 810 from the objective optics 125 to the beam splitter(s) 805. The objective beam 820 may be similarly embodied as beam 325 or beam 625. An ocular beam 825 may travel along the ocular optical path 815 from the beam splitter(s) 805 to the exit pupil 935 or a user's eye 340 during normal use. The ocular beam 825 may be similarly embodied as ocular beam 335 or ocular beam 635.

A display optical path 830 may be defined by the I/O device 115 between the display device 615 and the beam splitter(s) 805. A display beam 835 may travel along the display optical path 830 from the display device 615 to the beam splitter(s) 805. The display beam 835 may be similarly embodied as the display beam 630. The display beam 835 may include images indicative of support data.

A imager optical path 840 may be defined by the I/O device 115 between the beam splitter(s) 805 and the imaging device 315. An imager beam 845 may travel along the imager optical path 840 from the beam splitter(s) 805 to the imaging device 315. The imager beam 845 may be similarly embodied as the auxiliary beam 345.

While the illustrative example, shows that the optical paths 810, 815, 830, 840 as straight, in other examples, the optical paths 810, 815, 830, 840 may travel in many different directions. The beam splitter(s) 805 may be similarly embodied as beam splitter 305 or beam splitter 805.

In some examples, a single beam splitter 805 is used to both split the objective beam 820 and to split the display beam 835. For example, the single beam splitter 805 may be configured to transmit a first portion 850 of the objective beam 820 through the beam splitter 805 to travel along the ocular optical path 815 and reflect a second portion 855 of the objective beam 820 to travel along the imager optical path 840. Similarly the single beam splitter 805 may be configured to reflect a first portion 860 of the display beam 835 along the ocular optical path 815 and transmit a second portion 865 of the display beam 835 through the beam splitter 805 along the imager optical path 840. The ocular beam 825 may be a combination of the first portion 850 of the objective beam 820 and the first portion 860 of the display beam 835. The imager beam 845 may be a combination of the second portion 855 of the objective beam 820 and the second portion 865 of the display beam 835.

In some examples, two beam splitters 805 may be used. A first beam splitter 805 may be used to split the objective beam 820 into its first portion 850 and its second portion 855. A second beam splitter 805 may be used combine the first portion 850 of the objective beam 820 and the first portion 860 of the display beam 835. The second beam splitter 805 may also split the display beam into its first portion 860 and its second portion 865. In some instances, one or more optics may be used to redirect and combine the second portion 855 of the objective beam 820 and the second portion 865 of the display beam 835 to create the imager beam 845. In some instances, the imager beam 845 only includes the second portion 855 of the objective beam 820. In some instances, another computing device may combine the support data and the indicators with the image captured by the imaging device 315 to generate a composite image. The composite image being a replica of the image presented at the exit pupil 935.

As discussed above, the data display components 210 may be utilized with the image capture components 205. In some examples, the side of the beam splitter 805 facing the user may be utilized to project information from one or more display elements to the user, such that the information is laid over part or all of the incoming image in such a manner that it allows the user to see the incoming image from the optical device 110, but presents either visible data (e.g., digital information, such as, compass heading, range, wind speed, time, etc.) or a see-through regional overlay such that the digital image component accents the image from the optical device 110 with highlights (i.e. low light level image, thermal image, image processed components (e.g., marking of objects in motion, colorimetry data, object shape analysis, etc.). The user may have the ability to choose which display options are being used and where they are presented on the field of view.

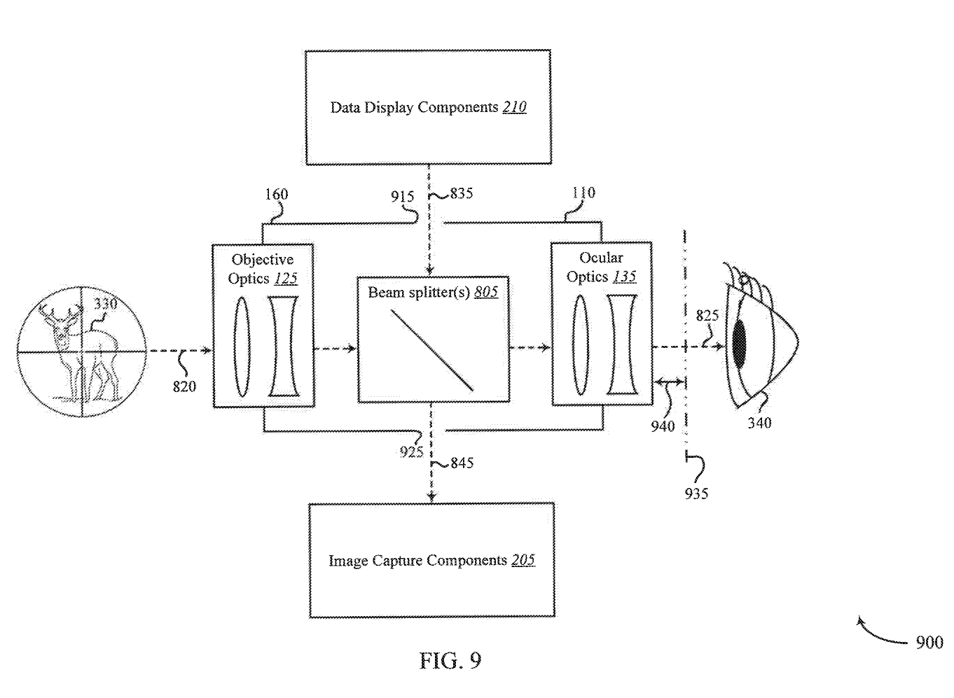

FIG. 9 shows a simplified block diagram 900 of an I/O device 905 positioned in the optical device 110. The I/O device 905 may be similarly embodied as the I/O device 115. The I/O device 905 may include beam splitter(s) 805, image capture components 205, and data display components 210. In some examples, the I/O device 905 may include either the image capture components 205 or the data display components 210.

The beam splitter(s) 805 may be positioned in a primary optical path 910 of the optical device 110 between the objective optics 125 and the ocular optics 135. The housing 120 of the optical device 110 may be modified to allow the various beams to enter and exit the housing 120. For example, an opening 915 may be formed in the housing 120 to allow a display beam 835 from the data display components 210 to enter the housing 120 and an opening 925 may be formed in the housing 120 to allow an imager beam 845 to exit the housing 120. Because the beam splitter(s) 805 are positioned between the objective optics 125 and the ocular optics 135, the image of the objective 330 split by the beam splitter(s) 805 may not be in focus. In such embodiments, the optics of the image capture components 205 and the data display components 210 may modify the images such that user of the optical device 110 observes indicators that are in focus after passing through the ocular optics 135 and the user of the computing device observes a useful image. In some examples, housings are positioned in and around the image capture components 205 and the data display components 210.

The optical device 110 may also define an exit pupil 935 and an eye relief 940. The exit pupil 935 is the image-forming light the optical device 110 presents to a user's eye 340. To use an optical device, an entrance pupil of the user's eye 340 should be aligned with and be of similar size to the exit pupil 935. This properly couples the optical system o the eye 340 and avoids vignetting. The position of the exit pupil 935 relative to the last surface of the optical device 110 determines the eye relief 940 of the optical device 110. The eye relief 940 is the distance between the last surface of the optical device 110 at which the user may observe a full viewing angle. An exit pupil 935 may have a diameter approximating the eye's apparent pupil diameter. If the exit pupil diameter is larger than the eye's pupil, light will be lost instead of entering the eye; if smaller, the view will be vignetted. If the exit pupil 935 is positioned too close to the last surface of the eyepiece, the eye may be uncomfortably close for viewing; if too far away, the user may have difficulty maintaining the eye's alignment with the exit pupil 935.

The I/O device 905 may be positioned to within the optical device 110 and prior to the eyepiece such that it diverts an image prior to passing through the eyepiece. In this manner, the user may utilize the optical device 110 without adjusting the eye relief 940 relative to the ocular optics 135. In this embodiment, optics for the imaging device may be modified to compensate for the optical elements that the image misses in the optical device 110 and thereby provides the imaging device with a comparatively similar viewing scene to the original optical device as viewed by the user.

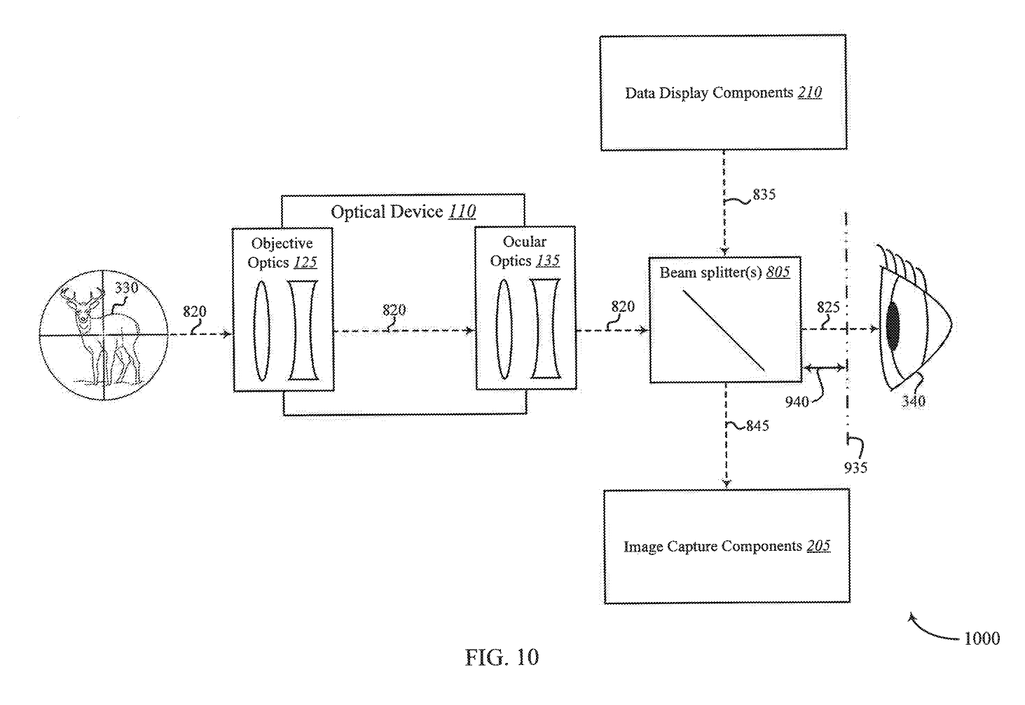

FIG. 10 shows a simplified block diagram 1000 of an I/O device 1005 positioned outside of the optical device 110. The I/O device 1005 may be similarly embodied as the I/O device 115. The I/O device 1005 may include beam splitter(s) 805, image capture components 205, and data display components 210. In some examples, the device 1005 may include either the image capture components 205 or the data display components 210 but not both.

The beam splitter(s) 805 may be positioned between in a primary optical path 1010 defined by the optical device 110 between the ocular optics 135 and the exit pupil 935. In some examples, the I/O device 1005 is contained within an I/O housing 160, In some examples, the I/O device 1005 may include additional optics that alter the position of the exit pupil 935. For example, if an attachment is added to the second end 140 of the optical device 110, the eye relief 940 may become uncomfortably small for the user. In such examples, the I/O device 1005 may include optics to move the eye relief such that it is a comfortable distance from the last optics of the I/O device 1005.

The I/O device 1005 may be positioned at the second end of the optical device 110. The I/O device 1105 may utilize the beam splitter(s) 805 placed between the eyepiece lens (e.g., ocular optics 135) and where the user would place their eye 340 to view the scene through the optical system (e.g., exit pupil 935). The beam splitter 805 may deflect part of the image light away from the observer position and direct it to an imaging device (either directly or via a folding mirror). The imaging device may be designed to accommodate the incoming image (or work with a correction lens) and bring it into focus on a digital imaging sensor. This allows a user of the optical device 110 to continue using the system in a normal manner, except for a slight increase in the distance from the eyepiece lens to their eye which provides the space needed for the beam splitter 805. It may also allow the image that the user sees through the optical device 110 to be imaged by the imaging device sensor and recorded in a digital memory, and/or transmitted to other devices. The use of a folding mirror in the design may allow for the imaging device and electronics package to be placed along the side of the housing 120 or near to an optical axis.

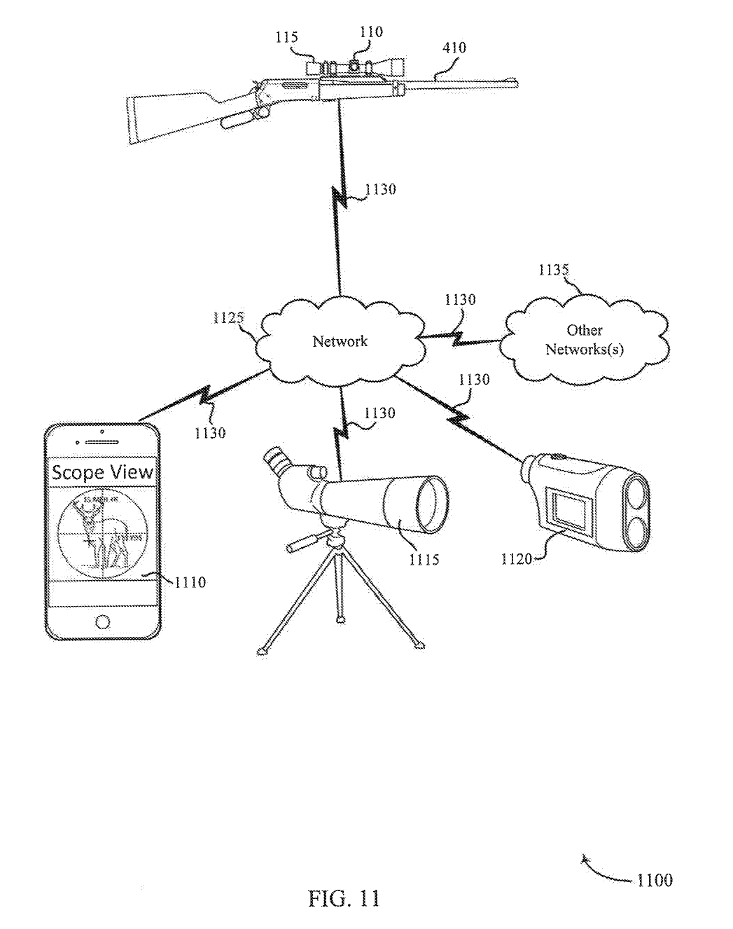

FIG. 11 shows an example of an integrated system 1100 of devices for communicating images and information with an optical device 110 having an I/O device 115. The I/O device 115 may be part of a larger ecosystem of connected devices to obtain and support data and to disseminate images captured by the I/O device 115. For example, the system 1100 may include the I/O device 115, a computing device 1110, a spotting scope 1115, a range finder 1120, a anemometer, a wind vane, a position locating device (e.g., a global positioning system device), or other types of devices. Some devices may be used to collect support data (e.g., scope 1115 or range finder 1120). These device may be set by the user of the I/O device 115 at locations desired by the user. In other examples, the support data may be collected from other sources or servers. Some device may be used to send and receive data. For example, the computing device 1110 may receive images or videos from the I/O device 115 and may supply support data to the I/O device 115. For example, the computing device 1110 may receive an input from a user such as drawing a circle on the image, the input (or circle) may then be displayed on the optical device 110 via the I/O device 115. The devices may be connected using a network 1125 via one or more communication links 1130.

The network 1125 may be a wired or wireless network, or any combination thereof, For example, the network 1125 may be embodied as Ethernet, Wi-Fi, cellular, LTE, Bluetooth, local area network, public network, optical network, the Internet, and/or any other type of network. The network 1125 may include more than one type of connection (e.g., wired and wireless connections) in a single implementation. In some examples, the network 1125 is an ad hoc network.

The network 1125 may be connected to one or more other networks 1135, such as the internet. From these other networks 1135, the I/O device 115 may send or receive data (e.g., the I/O device 115 may receive support data from these other networks). In some examples, the computing device 1110 acts as a gateway device for the I/O device 115. Meaning, the I/O device 115 may not connect to the other networks 1135 directly, but sends and receives data to and from these other networks 1135 through another device such as the computing device 1110.

The system 1100 may enable the I/O device 115 to be used in a number of applications. For example, by allowing the I/O device 115 to communicate through the network 1125 with other devices, images from a spotting scope, thermal imaging system, etc. may be shared, on-demand, with the I/O device 115, such that the user can switch between the image from the spotting scope 1115 and the optical device 110 coupled to the firearm 410. In a similar manner, support data from an electronic compass, GPS, range finder and/or other peripheral device may be shared via the network 1125. The data may be presented to the user through the I/O device 115 incorporated into the optical device 110. Network communication between the I/O device 115 and the peripheral products (e.g., mobile phones or other optical scopes), may be done in an encrypted format for security to prevent intrusion or interference from outside systems that could falsify or destroy the information.

In other examples, the I/O device 115 may incorporate image processing capabilities to utilize range, wind speed and other support data from various sensors and peripheral device to calculate an adjustment position from the crosshair point to the position of where a bullet will strike the target. The adjustment position may be presented to the user as the shot correction indicator 760 shown in FIG. 7. In some embodiments, the I/O device 115 may replace the physical crosshairs with an electronic crosshair presented to the user. The electronic crosshair may be configured to electronically shift from a preset/calibrated position to a new position correcting for the range, wind speed, etc. The electronic crosshairs may further allow the crosshairs preset/calibrated position to be rapidly changed to address a variety of issues, including, change of the type of bullet or load in the shells being used, compensation for the shooters habits/technique of firing a weapon, effects of altitude, etc. on the accuracy of the weapon. In some examples, another computing device (e.g., computing device 1110) may incorporate the image processing capabilities discussed above.

In other examples, the I/O device 115 and the system 1100 may be configured to perform other applications. The system 1100 may be configured to capture and record still images or video of animals, targets, scenes, etc. while hunting, or nature watching through a rifle scope, spotting scope, telescope, binoculars, or other optical devices 110. The system 1100 may be configured to share in real-time what the user of an optical device is seeing through the optical device 110. The system 1100 may be configured to allow a student or a teacher to view what the other sees and how they are aligning sights or centering an object of interest in the scene for image capture, shooting, etc. The system 1100 may be configured to observe animals and record identifying marks along with location and additional information via peripherals devices or the internal electronics of the I/O device 115. The system 1100 may be configured to display information pertinent to shooting a target or animal as accurately as possible. Such information can include wind speed and direction, range, altitude, etc. The information may be selectable based on the users requirements and the peripheral devices and sensors that are linked to the I/O device 115.

The system 1100 may be configured to integrate data from networked tools such as a range finder, wind speed and direction, and altitude are combine them with data on the type of weapon and shell being fired to provide corrected targeting information to accurately place a shot on target. Calculations may include the explosive type and number of grains and grain size being used in the shells being fired to provide accurate ballistic information. Some of this data may be input by a user into the system 1100. The system 1100 may be configured to display an electronic crosshairs where the position of the displayed crosshairs has been moved to match the data from calculations based on information from networked sensors, stored data and from the scope image. The system 1100 may be configured to use of data from sensors such as GPS and eCompass to identify the direction of fire that the user is planning, and comparing that with information from a maps application to indicate and warn the user of potential safety risk from firing in that position. This can include updated information of the presence and location of other hunters and observers.

The system 1100 may be configured to aid in competitions. For example, the system 1100 may record the location of a shot, video and/or still image of the shot to hit a target or animal. The eCompass and range data showing the location on a map of both the user and the target may also be recorded. This data may be used in target and/or hunting competitions. The information can then be compiled for each participant in the competition to indicate who made the most accurate shot, the longest shot, the most difficult shot, the size and class of the animal, and many more items of information. This opens a wide variety of competitive applications. These competitions can be applied to a variety of nature watching as well as hunting. In some embodiments, the system 1100 may determine a targeting skill parameter for a user based at least in part on a position of the objective in the image obtained by the optical device or based at least in part on a location of a projectile as it moves past the objective, compare the targeting skill parameter of the user to one or more other targeting skill parameters of other users of other optical devices, and indicate which of the users had a best targeting skill parameter.

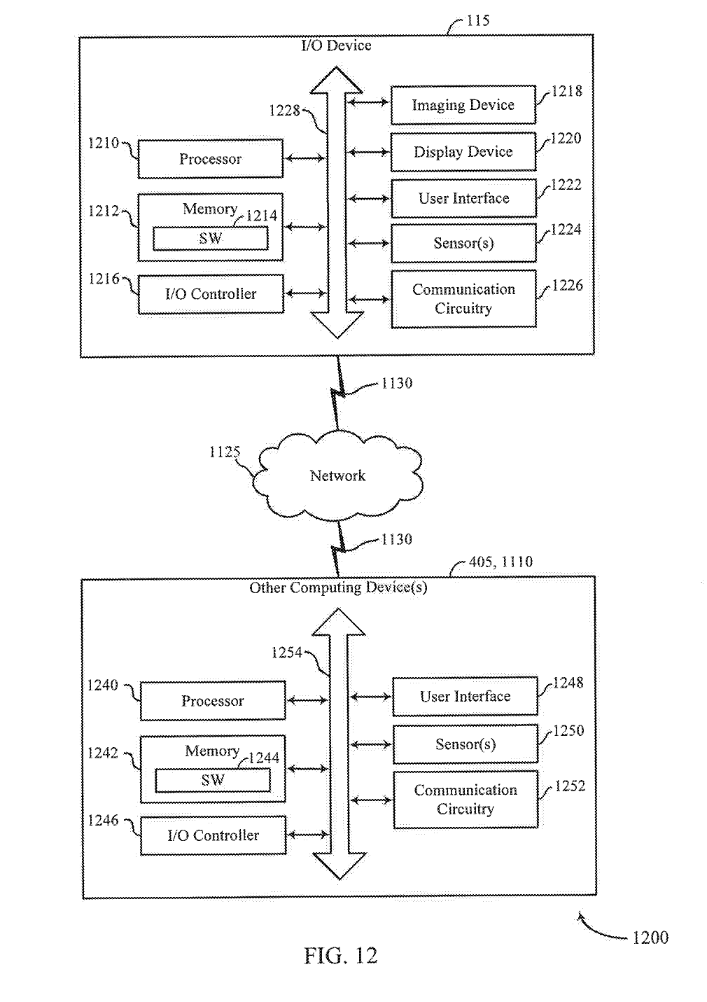

FIG. 12 shows examples of hardware implementations of the I/O device 115 and other computing device(s) 405, 1110. The other computing device(s) 405, 1110 may be embodied as any type of computing device capable of performing the functions described herein, and may be embodied as a server, a database, a personal computer, a laptop, a smartphone, a tablet, another handheld device, or any other type of computing device.

The I/O device 115 illustratively includes a processor 1210, memory, 1212, an Input/Output controller (I/O controller) 1216, a imaging device 1218, a display device 1220, a user interface 1222, one or more sensor(s) 1224, and communication circuitry 1226. One or more busses 1228 facilitate communication between one or more elements of the I/O device 115 (e.g., the processor 1210, the memory 1212, the I/O controller 1216, etc.). While the I/O device 115 is shown as a single unit, the elements and functions of the I/O device 115 may be distributed across multiple devices working together.

The processor 1210 may be embodied as any processor configured to perform the functions described herein (e.g., a controller, microprocessor, microcontroller, digital signal processor, etc.). The processor 1210 may include an intelligent hardware device, e.g., a central processing unit (CPU), a microcontroller, an application-specific integrated circuit (ASIC), etc. The processor 1210 is configured to execute a plurality of instructions based on the commands of the image capture components 205 and/or the data display components 210.

The memory 1212 may include random access memory (RAM), read only memory (ROM), flash RAM, and/or other types. The memory 1212 may store computer-readable, computer-executable software/firmware code 1214 including instructions that, when executed, cause the processor 1210 to perform various functions described in this disclosure (e.g., generating images of proposed products, generating proposed products based on user preference data, managing financial accounts of conditional funding, generating parameters indicative of future sales of a proposed product, and managing user feedback).

Although not specifically shown, it should be understood that the I/O controller 1216 typically includes, among other things, one or more I/O ports and a memory controller. The I/O controller 1216 is communicatively coupled to a number of components, including the processor 1210 and memory 1212.

The imaging device 1218 may be configured to perform the functions described in more detail with regard to FIGS. 2-5. In some embodiments, the imaging device 1218 may be similarly embodied as the image capture components 205. For example, the imaging device 1218 may be configured to capture and share images or video observed through an optical device 110 with the other computing devices 405, 1110.

The display device 1220 may be configured to perform the functions described in more detail with regard to FIGS. 2 and 6-8. In some embodiments, the display device 1220 may be similarly embodied as the data display components 210. For the example, the display device may be configured to obtain support data and overlay that support data on an image observed by a user through an optical device 110.

The user interface 1222 may include one or more input devices (e.g., a keyboard, mouse, microphone, touchscreen, switching, toggles, etc.) and one or more output devices (e.g., visual displays, LEDs or other indicators, audio speakers, etc.).

The user interface 1222 is configured to allow a user of the I/O device 115 to access, execute, and manipulate functions performed by the I/O device 115.

The sensors 1224 may include one or more sensors to detect current conditions of the I/O device 115 or present around the I/O device 115. For example, the sensors 1224 may include a position detection device (e.g., a GPS sensor), an accelerometer, a compass, an eCompass, a range determiner, lidar, radar, a wind vector determiner, or other types of sensors. In some embodiments, these sensors may be incorporated directly into the I/O device 115. In other embodiments, these sensors 1224 may be hardware in communication with the I/O device 115. In other embodiments, these sensors are part of one or more other peripheral computing devices (e.g., see FIG. 11).

The communication circuitry 1226 may communicatively couple the I/O device 115 to other computing devices 405, 1110, databases, and/or systems by through a wired or wireless connection 1130 via the network 1125. The communication circuitry 1226 is configured to transmit and receive information to and from the I/O device 115 using any typical communication protocol, for example, Wi-Fi, Wi-Max, cellular, LTE, Ethernet, Bluetooth, Internet Protocol, or any other type of communication protocol. Accordingly, the communication circuitry 1226 may include one or more optical, wired and/or wireless network interface subsystems, cards, adapters, a telephony subsystem, or a radio frequency transceiver and other associated hardware (e.g., amplifiers). The communication circuitry 1226 may be embodied as a modem configured to modulate packets and provide the modulated packets to other devices through the network 1125. The communication circuitry 1226 may also enable shorter-range wireless communications using, for example, near-field communication technology.

Referring now to the other computing devices 405, 1110 of FIG. 12, the other computing devices 405, 1110 may be embodied as any type of device that is capable of performing the functions described herein. In some examples, the other computing device may also include the peripheral devices described in relation to FIG. 11. For example, the other computing devices 405, 1110 may be a desktop computer, a laptop, a tablet, a smartphone, or another type of computing device. The other computing devices 405, 1110 may include components similar to those of the I/O device 115. For example, the other computing devices 405, 1110 may include a processor 1240, memory 1242, an I/O controller 1246, a user interface 1248, sensors 1250, and communication circuitry 1252, all connected via one or more busses 1254. In general, elements of the other computing devices 405, 1110 having the same or similar name as the elements of the I/O device 115 may be embodied similarly, and a full description of those elements is not repeated here. While not specifically shown in FIG. 12, the other computing devices 405, 1110 may include other components as needed to perform its functions.

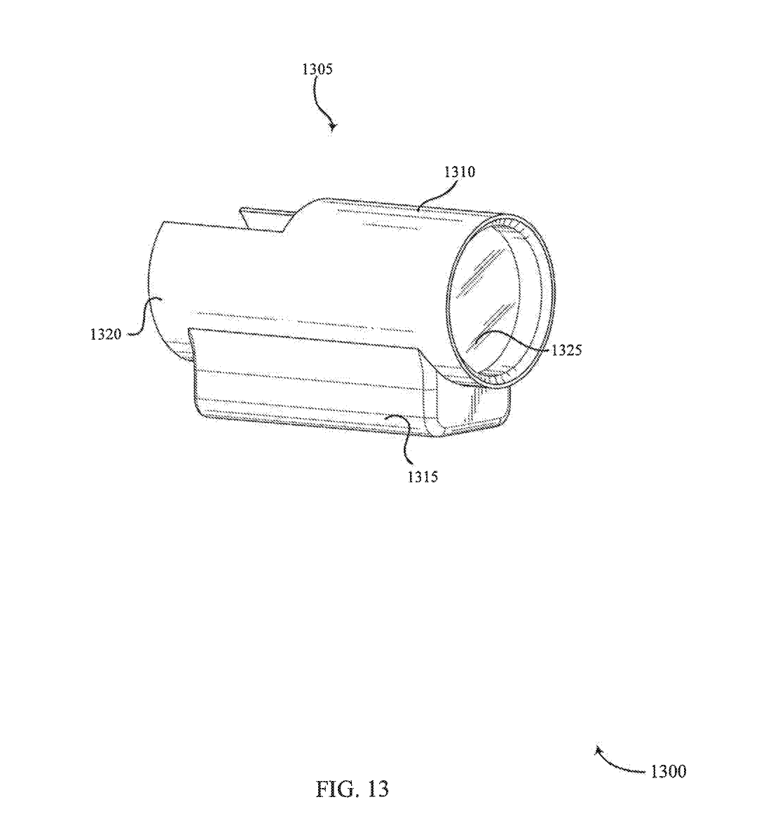

FIG. 13 shows an example of an I/O device 1300. The I/O device 1300 may be similarly embodied as the I/O device 115. The I/O device 1300 may include an I/O housing 1305, which in turn may include a beam splitter housing 1310, an electronics housing 1315, and an optical device housing 1320. The I/O device 1300 may be an example of the I/O device 1005. A beam splitter and/or other optics (such as lens 1325) may be positioned in the beam splitter housing 1310. The beam splitter housing 1310 may be designed to accept a beam of light traveling through the optical device 110 and allow at least a portion of that beam of light to pass through the lens(es) 1325 and travel toward the user's eye 340. The lens(es) 1325 may be configured to maintain a comfortable eye relief 940 for the user even though the illustrative I/O device 115 effectively extends the length of the optical device 110. The beam splitter may be configured to redirect a portion of the beam of light to an imaging device (e.g., a camera or a CCD (charge-coupled device) image sensor) positioned in the electronics housing 1315. The electronics housing 1315 may be configured to hold a number of electronic devices and optics as described in more detail in FIGS. 2, 3, 6, and 12. For example, the electronics housing 1315 may hold an imaging device, communication circuitry, a power source, and/or optics such as a mirror or other optics.

The optical device housing 1320 may be sized to receive the housing 120 of the optical device 110. The optical device housing 1320 may also be configured to secure the I/O device 1300 in a fixed position relative to the optical device 110 using some type of fixation means. For example, the optical device housing 1320 may couple to the optical device 110 via a friction fit, a fastener such as a screw, strap, or adhesive, or some other type of fastener. In some examples, the I/O housing 1305 may include only the electronics housing 1315 because the beam splitter and the other optics may be integrated into the optical device 110 such that the beam splitter and the other optics are positioned in the housing 120 (e.g., I/O device 905).

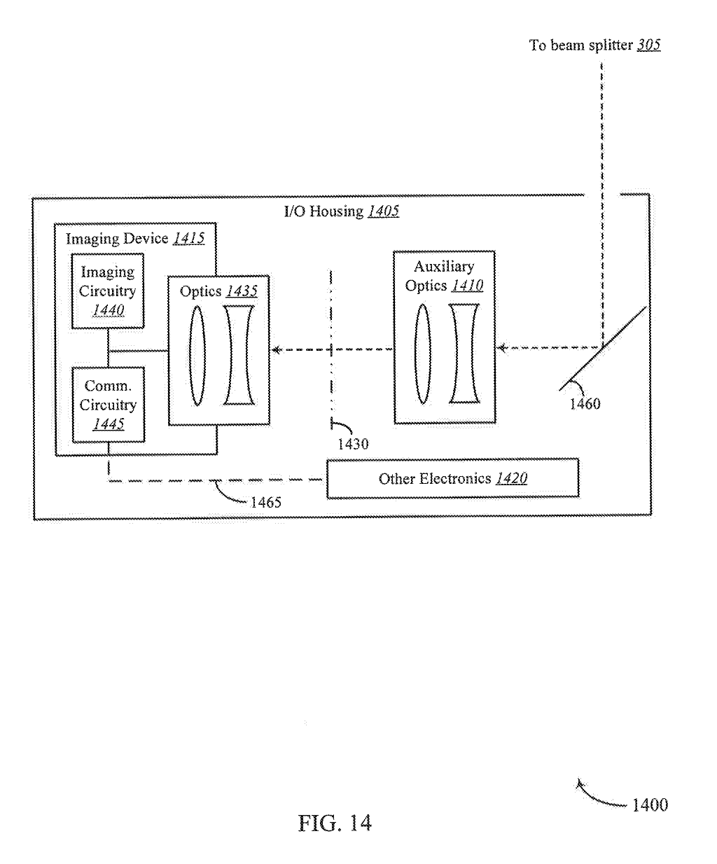

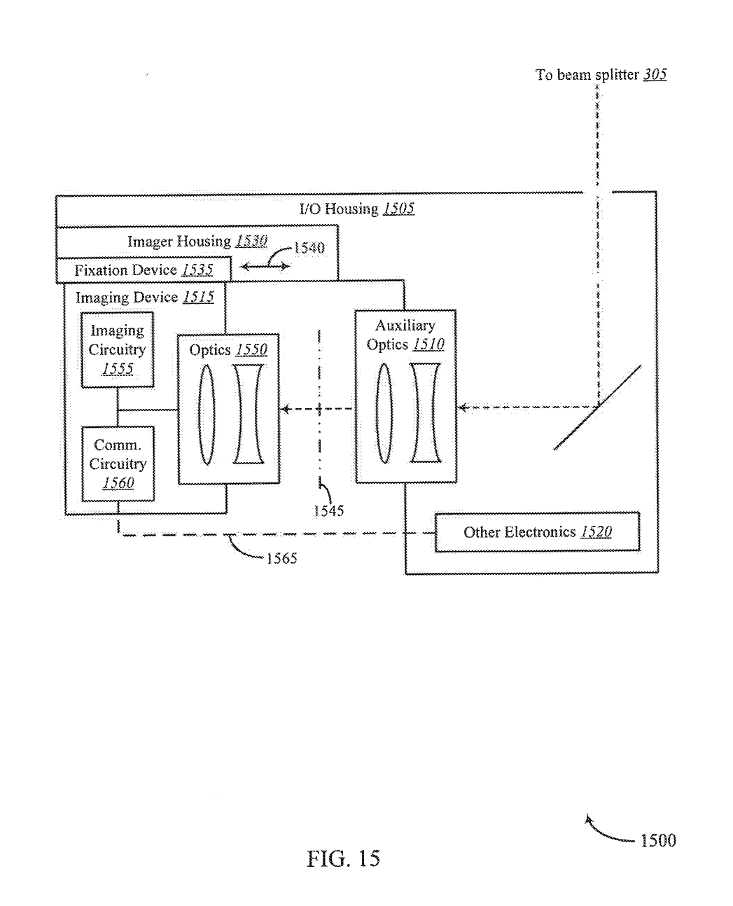

FIGS. 14 and 15 illustrate simplified block diagrams of different examples of the I/O housings 1305. In some examples, an imaging device 1415 may be integrated directly into the I/O device 115 such that the imaging device 1415 may be specially built and installed permanently in the I/O device 115. In other examples, the imaging device 1415 may be any commercial available imaging device that may be selectively coupled to the I/O device 115.

FIG. 14 shows a simplified block diagram 1400 of an I/O housing 1405 of the I/O device 115. The I/O housing 1405 may be similarly embodied as the I/O housings 160, 1305 described above. In some examples, the I/O housing 1405 may be only a portion of the I/O housing 1305 described above. The I/O housing 1405 may include auxiliary optics 1410, an imaging device 1415, and other electronics 1420. The imaging device 1415 may be integrated directly into the I/O housing 1405 such that the imaging device 1415 may be specially built and installed permanently in the I/O device 115.

In use, the beam 1425 of light may be received into the I/O housing 1405 through an opening 1455 formed in the I/O housing 1405. Once inside the cavity of the I/O housing 1405, the beam 1425 may be redirected according to the position and configuration of the imaging device 1415 and the auxiliary optics 1410. For example, the beam 1425 may be redirected by a folding mirror 1460. The auxiliary optics 1410 are configured to adjust the beam 1425 on the optics 1435 of the imaging device 1415. In some examples, this is done by altering the position and/or the diameter of the auxiliary exit pupil 1430. The beam 1425 is then received into the imaging device 1415. The imaging device generates an image based at least in part on the beam 1425. The image is then communicated by communication circuitry 1445 or other electronics 1420 to another computing device 405 via a network. In some examples, the components positioned in the I/O housing 1405 (e.g., 1410, 1415, 1420) may be similarly embodied as the image capture components 205.

In some examples, a link 1465 may be established between the communication circuitry 1445 and the other electronics 1420. For example, in some cases, the imaging device 1415 may not be capable of connecting to a network. In such an example, the imaging device 1415 may connect to the other electronics 1420 via a wired link or a wireless link (e.g., link 1465), and the other electronics 1420 may connect to the network.

FIG. 15 shows a simplified block diagram 1500 of another example of a I/O housing 1505 the I/O device 115. The I/O housing 1405 may be similarly embodied as the I/O housings 160, 1305 described above. In some examples, the I/O housing 1505 may be only a portion of the I/O housing 1305 described above. The I/O housing 1505 may include the auxiliary optics 1510, the imaging device 1515, and the other electronics 1520 described above. As such, a description of the auxiliary optics 1510 and the other electronics is not repeated here. The imaging device 1515 may be embodied as any imaging device or any commercially available imaging device. In the illustrative example, the I/O housing 1505 is configured to selectively couple to any number of imaging devices 1515. For example, I/O housing 1505 may couple to a digital camera, a camera of a smartphone, or a PCB board with imaging components attached thereto.

The I/O housing 1505 may include an imager housing 1530 configured to receive the imaging device 1515. The imager housing 1530 may be designed to receive a plurality of different types of imaging devices 1515. The imager housing 1530 may include a fixation device 1535 to couple the imaging device 1515 to the imager housing 1530 in a fixed position relative to the imager housing 1530. The imager housing 1530 may be movably coupled to the I/O housing 1505. For example, the imager housing 1530 may be slidably adjustable along an axis 1540 of the I/O housing 1505. In some examples, the imager housing 1530 may be movable in three dimensions of the I/O housing 1505. In this way, the imaging device 1515 may reposition the imaging device 1515 depending on the type of imaging device being used. In some examples, the imager housing 1530 is also configured to adjust the yaw pitch and roll of the imaging device 1515 that is coupled thereto via the fixation device 1535.

In some examples, the fixation device 1535 is movable coupled to the imager housing 1530 in the manner described above and the imager housing 1530 is coupled to the I/O housing 1505 in a fixed position relative to the I/O housing 1505. The fixation device 1535 may include any type of means of securing the imaging device 1515 to the I/O housing 1505. For example, the fixation device 1535 may include a fasteners, a screw, a strap, velcro, adhesives, a friction fit created by the shape and orientation of the imager housing 1530 or other types of fastening means.

The imaging device may include optics 1550, imaging circuitry 1555 or communication circuitry 1560. These components 1550, 1555, 1560 may be similarly embodied as the components described in relationship to the image capture components 205. The optics 1550 may be any type of lens or other optic used by the imaging device 1515. The imager housing 1530 may be configured to adjust a position and orientation of the imaging device 1515 relative to the auxiliary optics 1510. In addition, the auxiliary optics 1510 may be configured to adjust a position, orientation, and size of the auxiliary exit pupil 1545 to better align with the optics 1550 of the imaging device 1515.

In some examples, a link 1565 may be established between the communication circuitry 1560 and the other electronics 1520. For example, in some cases, the imaging device 1515 may not be capable of connecting to a network. In such an example, the imaging device 1515 may connect to the other electronics 1520 via a wired link or a wireless link (e.g., link 1565), and the other electronics 1520 may connect to the network.

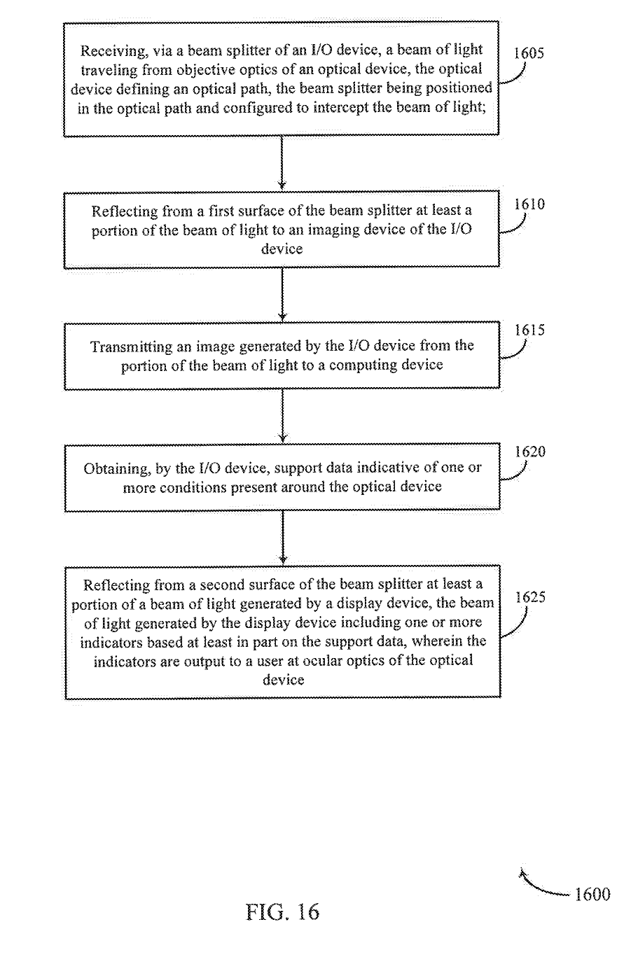

FIG. 16 shows a flowchart illustrating a method 1600 for sharing and displaying data through an optical device 110, The operations of method 1600 may be implemented by an I/O device 115 or its components as described herein. For example, the operations of method 1600 may be performed by an I/O device as described with reference to FIGS. 1 through 15. In some examples, an I/O device 115 may execute a set of codes to control the functional elements of the device to perform the functions described below. Additionally or alternatively, the I/O device 115 may perform aspects the functions described below using special-purpose hardware. The operations of blocks 1605-1625 may be performed according to the methods described with reference to FIGS. 1 through 15.

At block 1605, the I/O device 115 may receive, via a beam splitter of an I/O device, a beam of light traveling from objective optics of an optical device, the optical device defining an optical path, the beam splitter being positioned in the optical path and configured to intercept the beam of light.

At block 1610, the I/O device 115 may reflect from a first surface of the beam splitter at least a portion of the beam of light to an imaging device of the I/O device.

At block 1615, the I/O device 115 may transmit an image generated by the I/O device from the portion of the beam of light to a computing device

At block 1620, the I/O device 115 may obtain, by the I/O device, support data indicative of one or more conditions present around the optical device.

At block 1625, the I/O device 115 may reflect from a second surface of the beam splitter at least a portion of a beam of light generated by a display device, the beam of light generated by the display device including one or more indicators based at least in part on the support data, wherein the indicators are output to a user at ocular optics of the optical device.

In some embodiments, method 1600 may further include receiving a visual indicator from the computing device, the visual indicator being input by drawing on the image output by the computing device, and outputting the visual indicator at the ocular optics to the user of the optical device.

In some embodiments, method 1600 may further include identifying one or more characteristics of an animal present in the image, determining animal tracking data based at least in part on the one or more characteristics of the animal, and outputting animal tracking data at the ocular optics to the user of the optical device.

In some embodiments, method 1600 may further include receiving, via a computer network, the support data from one or more other devices positioned in a proximity to the optical device.

In some embodiments, method 1600 may further include that the support data includes at least one of a wind speed, a wind direction, a range to an objective, an altitude, or a location of the optical device, and that the one or more other devices includes at least one of a range finder, an altimeter, a global positioning system device, an anemometer, a wind vane, or a thermal imager.

In some embodiments, method 1600 may further include determining a targeting correction based at least in part on the image and the support data, and outputting a targeting correction indicator at the ocular optics to the user of the optical device based at least in part on the targeting correction.

In some embodiments, method 1600 may further include determining direction that the optical device is pointed based at least in part the image received from the optical device and location data indicative of a location of the optical device, and warning the user of the optical device of any possible hazards if a weapon is discharged in the direction that the optical device is pointed.

In some embodiments, method 1600 may further include determining a targeting skill parameter for the user based at least in part on a position of an objective in the image obtained by the optical device or based at least in part on a location of a projectile as it moves past the objective, comparing the targeting skill parameter of the user to one or more other targeting skill parameters of other users of other optical devices, and indicating which of the users had a best targeting skill parameter.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired, For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. An apparatus comprising:
an optical device having a housing with objective optics positioned at a first end of the housing and ocular optics positioned at a second end of the housing, the optical device defining a primary optical path between the objective optics and an exit pupil;
a beam splitter positioned in the primary optical path and configured to divide a primary beam traveling along the primary optical path into a first beam traveling along the primary optical path and a second beam traveling along an auxiliary optical path different than the primary optical path; and
one or more auxiliary lenses positioned in the auxiliary optical path to focus the second beam on a lens of a camera.

2. The apparatus of claim 1, further comprising:
a camera housing positioned adjacent to an auxiliary exit pupil defined by the auxiliary optical path, the camera housing sized to receive the camera and configured to secure the camera in a fixed position relative to the auxiliary exit pupil.

3. The apparatus of claim 1, wherein the beam splitter is positioned in the primary optical path between the ocular optics and the exit pupil.

4. The apparatus of claim 3, further comprising:
an auxiliary housing coupled to the housing of the optical device at the second end, the one or more auxiliary lenses being positioned within a beam splitter housing.

5. The apparatus of claim 3, further comprising:
one or more primary lenses positioned in the primary optical path between the beam splitter and the exit pupil to alter a position of the exit pupil relative to the ocular optics.

6. The apparatus of claim 5, wherein the one or more primary lenses are configured to adjust an eye relief of the optical device based at least in part on the position of the beam splitter in the primary optical path.

7. The apparatus of claim 1, wherein the beam splitter is positioned in the primary optical path between the objective optics and the ocular optics.

8. The apparatus of claim 7, wherein the housing further comprises:
an opening being positioned to allow the second beam to exit the housing at a location different from the ocular optics.

9. An apparatus comprising:
an optical device having a housing with objective optics positioned at a first end of the housing and ocular optics positioned at a second end of the housing, the optical device defining a primary optical path;
a beam splitter positioned in the primary optical path to divide a first objective beam traveling from the objective optics along the primary optical path into a second objective beam and third objective beam, the third objective beam traveling along an auxiliary optical path different than the primary optical path; and
a display positioned to cooperate with the beam splitter to define a display optical path, the display to generate a display beam that travels along the display optical path to the beam splitter, the display optical path being different than the primary optical path;
wherein the second objective beam and the display beam cooperate to present an image at an exit pupil of the optical device.

10. The apparatus of claim 9, wherein the image presented at the exit pupil includes an objective represented in the first objective beam and support information represented in the display beam.

11. The apparatus of claim 10, wherein the support information includes environmental information.

12. The apparatus of claim 10, wherein the support information includes a targeting correction indicator.

13. The apparatus of claim 9, wherein the beam splitter combines the first objective beam and at least a portion of the display beam into an ocular beam that travels along the primary optical path to the exit pupil.

14. The apparatus of claim 9, wherein the third objective beam travels along the auxiliary optical path to an imaging device, the third objective beam presenting an auxiliary image of an objective at an auxiliary exit pupil of the optical device.

15. The apparatus of claim 9, wherein:
the beam splitter forms the second objective beam by allowing a first portion of the objective beam to pass through the beam splitter and travel along the primary optical path; and
the beam splitter forms the third objective beam by reflecting a second portion of the objective beam along the auxiliary optical path.

16. The apparatus of claim 9, wherein the beam splitter divides the display beam into a second display beam traveling along the primary optical path and a third display beam. traveling along the auxiliary optical path.

17. The apparatus of claim 16, wherein the third objective beam and the third display beam cooperate to define an auxiliary image at an auxiliary exit pupil that includes an objective represented in the first objective beam and support information represented in the display beam.

18. The apparatus of claim 9, further comprising:
a wireless communication device to receive support information from one or more other computing devices via a communication network.

19. A method comprising:
receiving, via a beam splitter of an I/O device, a beam of light traveling from objective optics of an optical device, the optical device defining an optical path, the beam splitter being positioned in the optical path and configured to intercept the beam of light;
reflecting from a first surface of the beam splitter at least a portion of the beam of light to an imaging device of the I/O device;
transmitting an image generated by the I/O device from the portion of the beam of light to a computing device;
obtaining, by the I/O device, support data indicative of one or more conditions present around the optical device; and
reflecting from a second surface of the beam splitter at least a portion of a beam of light generated by a display device, the beam of light generated by the display device including one or more indicators based at least in part on the support data, wherein the indicators are output to a user at ocular optics of the optical device.

20. The method of claim 19, further comprising:
receiving a visual indicator from the computing device, the visual indicator being input by drawing on the image output by the computing device; and
outputting the visual indicator at the ocular optics to the user of the optical device.

21. The method of claim 19, further comprising:
identifying one or more characteristics of an animal present in the image;
determining animal tracking data based at least in part on the one or more characteristics of the animal; and
outputting animal tracking data at the ocular optics to the user of the optical device.

22. The method of claim 19, wherein obtaining the support data further comprises:
receiving, via a computer network, the support data from one or more other devices positioned in a proximity to the optical device.

23. The method of claim 22, wherein:
the support data includes at least one of a wind speed, a wind direction, a range to an objective, an altitude, or a location of the optical device; and
the one or more other devices includes at least one of a range finder, an altimeter, a global positioning system device, an anemometer, a wind vane, or a thermal imager.

24. The method of claim 19, further comprising:
determining a targeting correction based at least in part on the image and the support data; and
outputting a targeting correction indicator at the ocular optics to the user of the optical device based at least in part on the targeting correction.

25. The method of claim 19, further comprising:
determining a direction that the optical device is pointed based at least in part the image received from the optical device and location data indicative of a location of the optical device; and
warning the user of the optical device of any possible hazards if a weapon is discharged in the direction that the optical device is pointed.

26. The method of claim 19, further comprising:
determining a targeting skill parameter for the user based at least in part on a position of an objective in the image obtained by the optical device or based at least in part on a location of a projectile as it moves past the objective;
comparing the targeting skill parameter of the user to one or more other targeting skill parameters of other users of other optical devices; and
indicating which of the users had a best targeting skill parameter.
